(19) United States
(12) Patent Application Publication
(10) Pub. No.: US 2010/0086749 A1
(43) Pub. Date: Apr. 8, 2010

(54) HETEROGENEOUS, ESPECIALLY MULTICOLORED SHEET MATERIAL, MOLD AND METHOD

(75) Inventors: Hubert Bruckner, Erkrath (DE); Heinz Dieter Wellen, Krefeld (DE); Jorg Hendrix, Nettetal (DE); Peter Cempulik, Selm (DE)

Correspondence Address: Johnson Controls, Inc.;c/o Fletcher Yoder PC, P.O. Box 692289, Houston, TX, 77269, US

(73) Assignee: Johnson Control Technology Company, Holland (US)

(21) Appl. No.: 12/444,247

(22) PCT Filed: Sep. 5, 2007
(86) PCT No.: PCT/EP07/07733

§ 371 Date: Dec. 21, 2009

(30) Foreign Application Priority Data
Oct. 6, 2006 (DE) 102006047736.7

(51) Int. Cl. B29C 39/12; B29C 39/10

(52) U.S. Cl. 428/194; 264/260; 425/120

(57) ABSTRACT

A heterogenous sheet material comprises first and second plastics materials joined together at edges by a strand element with a hollow profile. The material may be made by filling mold cavities with flowable plastics materials, with a sealing element placed in the mold between the cavities before cavities are filled. The plastic materials and sealing element form an integral part. The material may be multicolored, and may be used as a decorative skin for an inner lining part of a motor vehicle.

### CROSS REFERENCE TO RELATED APPLICATIONS

This application claims priority from and the benefit of PCT Application No. PCT/EP2007/007733, filed on Sep. 5, 2007; and German Patent No. DE 10 2006 047 736.7, filed on Oct. 6, 2006; both entitled “Heterogeneous, Especially Multicoloured Sheet Material, Tool and Method”, which are herein incorporated by reference.

### BACKGROUND

The invention relates to a heterogeneous, preferably multicolored sheet material, especially a decorative skin for an inner lining part of a motor vehicle, consisting of a first and a second plastics material, which are joined together at the edges thereof by means of an element in the form of a strand, and also to a suitable production method and a mold.

A sheet material of the generic type is known from the document DE 10 2004 059 066 A1. To produce multicolored decorative skins for dashboards or the like, a mold with two adjacent cavities is filled with two differently colored curing plastics materials. The transition between the cavities is sealed by an elastic sealing element in the form of a strand, which, before the mold is filled, is placed in a groove provided in the upper mold and given an undercut and, after the mold is closed, is pressed against a rib of the lower mold in a sealing manner. During the curing of the plastics materials, they join with the compact sealing element, which thereby becomes an integral part of the subsequently demolded sheet material.

This method entails the risk of the sealing element being damaged if the sheet material is demolded quickly. In addition, placement of the sealing element in the upper mold requires a relatively great force to be expended.

The same document describes a mold in which a sealing element which can expand under fluid pressure, but remains permanently in the mold and is only exchanged in the event of becoming worn, is provided for sealing the first cavity with respect to the second cavity. The two plastics materials are directly joined together in the finished sheet material.

### SUMMARY

The invention is based on the problem of improving the previously known sheet material with respect to reducing the risk of the sealing element becoming damaged during demolding. In addition, placement of the sealing element is to be made easier, in particular when the groove follows a complicated path. Furthermore, the possibilities of creating different designs of the sealing element are to be increased and any further processing of the sheet material is to be made easier.

The problem is solved in the case of the sheet material according to the invention by the sealing element being formed as a hollow profile which is subjected to a fluid pressure during the filling of at least one cavity.

To produce such a sheet material, at least a first cavity and a second cavity of a mold are filled with at least a first and a second flowable plastics material, which form a one-piece sheet material after removal from the mold, a sealing element being arranged between the cavities, which sealing element is placed in the mold before the cavities are filled and is subsequently joined together with the plastics materials, preferably with an integral bond, and is removed from the mold as an integral part of the sheet material, the sealing element being formed as a hollow profile which is subjected to a fluid pressure during the filling of at least one cavity.

A mold suitable for carrying out this method has at least a first mold part and a second mold part, which can be displaced with respect to said first part, which parts form at least a first cavity and an adjacent second cavity when the mold is closed, which cavities are sealed with respect to each other by means of a sealing element to be replaced before each production cycle and can be filled with at least a first and a second flowable plastics material, the mold having according to the invention a fluid pressure connection which can be connected to the sealing element.

### DRAWINGS

The figures represent various embodiments of the invention schematically and by way of example.

FIG. 1 shows a first sheet material according to the invention,

FIG. 2A-G show a method and a mold for producing a sheet material according to a first embodiment of the invention,

FIG. 3 shows a preferred embodiment of a sealing element,

FIG. 4 shows a further sheet material according to the invention,

FIG. 5 shows a sealing element arrangement according to another embodiment of the invention.

### DETAILED DESCRIPTION

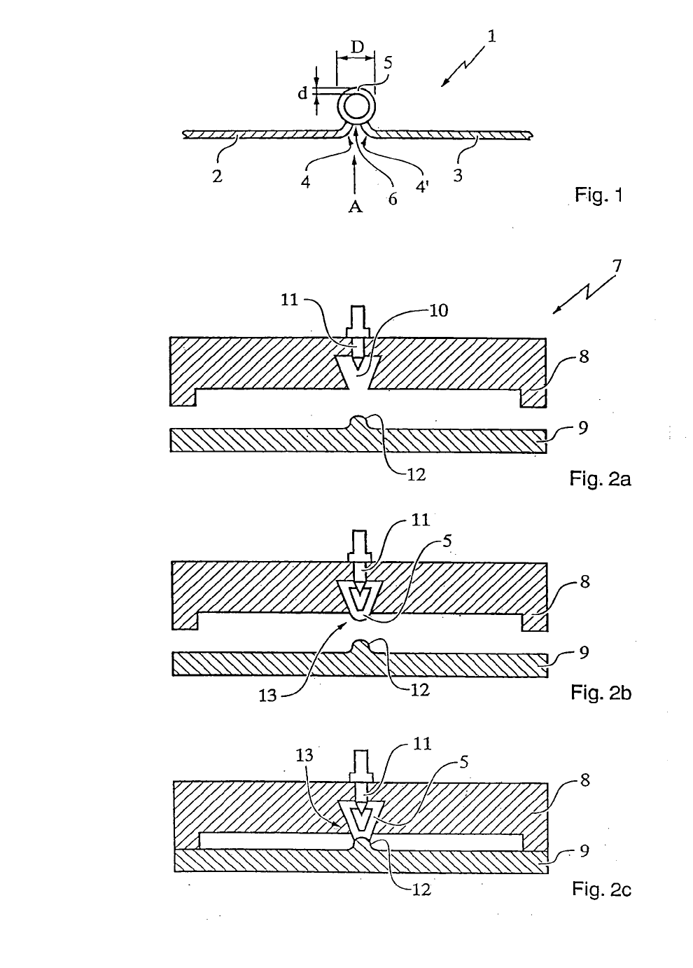

The sheet material 1 represented in FIG. 1 consists of a first cured plastics material 2 and a second cured plastics material 3, which have different colors and are joined along the mutually facing edges 4, 4′ indirectly by means of an annular tube-like hollow profile 5, to which they adhere with an integral bond. From the visible side A, the hollow profile 5 appears only as a narrow strip at the base of a shadow gap 6.

UV-resistant, chemically curing polyurethanes are preferably used as plastics materials 2, 3, while the hollow profile 5 advantageously consists of a thermoplastic polyurethane. In the case of a decorative skin for an inner lining part of a vehicle, the outside diameter D of the hollow profile 5 is, for example, 3 mm, having a wall thickness d of less than 1 mm, for example 0.5 mm. Such a hollow profile 5 has adequate tear resistance, but still makes a certain alignment of the plastics materials 2, 3 possible during the later foam backing of the decorative skin.

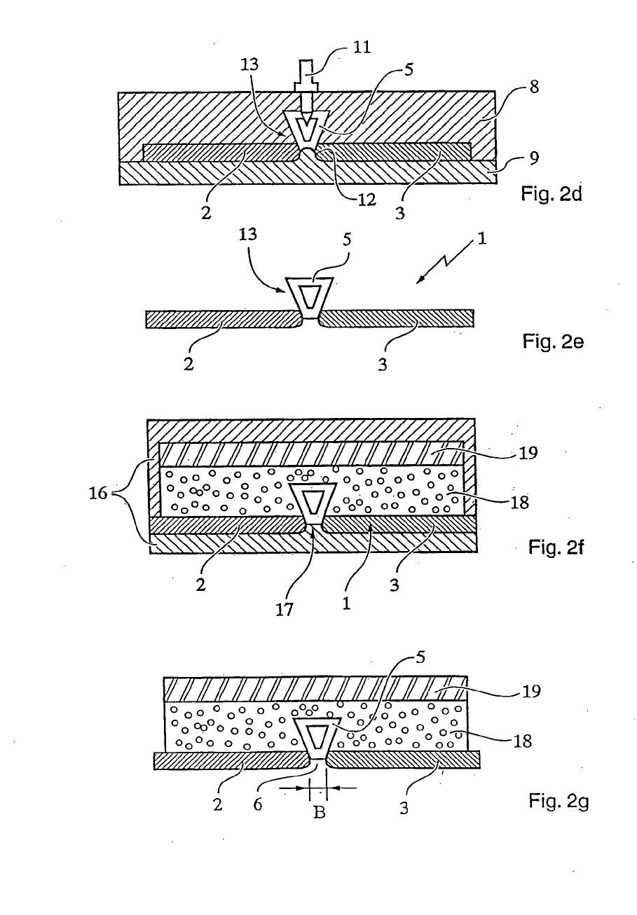

Methods and molds for the production and further processing of the sheet material are described below on the basis of a further exemplary embodiment with reference to FIGS. 2a to 2g.

The mold 7 represented in FIG. 2a comprises an upper mold 8 and a lower mold 9, which is movable in relation to said upper mold. The upper mold 8 is provided with a groove 10, which widens trapezoidally away from the lower mold 9 and into which there enters a pressurized fluid connection 11 (generally compressed air). The lower mold 9 has a rib 12 projecting in the direction of the groove 10.

As can be seen from FIG. 2b, a substantially likewise trapezoidal sealing element 13 in the form of a strand, formed as a hollow profile 5, is placed in the groove 10 and securely held by the undercut of the groove 10 but, because of its deformability, can be placed in the groove 10 with relatively little force being exerted. During placement, the still pressure-free pressurized fluid connection 11 pierces the sealing element 13, which is closed at the end, so that subsequently there is the possibility of feeding a pressurized fluid into the hollow profile 5.

Subsequently, the mold 7 is closed and the hollow profile 13 is subjected to a pressurized fluid, so that the sealing element 13 comes to lie against the rib 12 (FIG. 2c). The mold 7 then forms two adjacent cavities 14, 15, which are sealed with respect to each other and are subsequently filled with the still flowable plastics materials 2, 3 of different colors (FIG. 2d). In the processing of chemically curable polyurethane materials, an injection pressure of 10 bar is generally adequate. The fluid pressure in the sealing element 13 is to be set only a little higher. The filling can take place successively, but also substantially simultaneously to reduce the production time.

Before the sheet material 1 produced in this way is demolded (FIG. 2e), the fluid pressure in the sealing element 13 is lowered to ambient pressure, so that the hollow profile 5 then joined undetachably and integrally to the plastics materials 2, 3 can be removed from the groove 10 without any problem. The width of the shadow gap 6 can then be changed within certain limits by deforming the hollow profile 5.

Subsequently, the sheet material 1 is placed in a foam backing device 16, in which a further rib 17 penetrates into the shadow gap 6 and exactly defines the ultimate width thereof. By introducing a curing foam 18, the sheet material 1 is subsequently firmly joined to a rigid support 19, for example a dashboard (FIG. 2f).

In the case of the composite body 20 created in this way (FIG. 2g), the width B of the shadow gap 6 is exactly set.

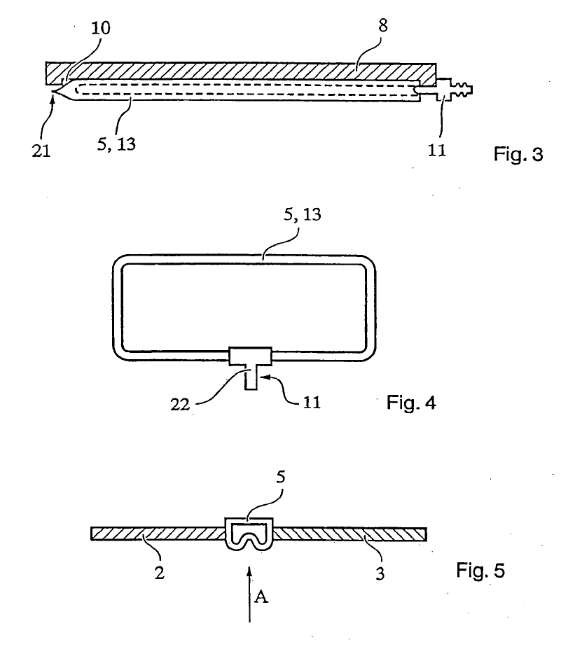

Instead of the previously described piercing of the pressurized fluid connection 11, one end of the hollow profile 5 may be closed, for example by a welded joint 21, the required length of the sealing element 13 supplied on a reel cut off and the open end fitted onto the pressurized fluid connection 11 of the upper mold 8 (FIG. 3).

In the case of sealing elements 13 in the form of frames which completely surround a plastics material of a different color, the hollow profile 5 may be fitted with both open ends onto a T piece 22, which is connected to the pressurized fluid connection 11 (FIG. 4).

In the case of the sheet material 1 as shown in FIG. 5, the hollow profile 5 is quite deliberately formed as a design element, the decorative part of its periphery protruding toward the visible side A.

1. A heterogeneous sheet material, especially comprising, a first and a second plastics material, which are joined together at edges thereof by means of an element in the form of a strand formed as a hollow profile.

2. A method for producing the sheet material as claimed in claim 1, in which at least a first cavity and a second cavity of a mold are filled with at least a first and a second flowable plastics material, which form a one-piece sheet material after removal from the mold, a sealing element being arranged between the cavities, which sealing element is placed in the mold before the cavities are filled and is subsequently joined together with the plastics materials, and is removed from the mold as an integral part of the sheet material, the sealing element being formed as a hollow profile which is subjected to a fluid pressure during the filling of at least one cavity.

3. A mold for producing the sheet material as claimed in claim 1, with at least a first mold part and a second mold part, which can be displaced with respect to the first part, which parts form at least a first cavity and an adjacent second cavity when the mold is closed, which cavities are sealed with respect to each other by means of a sealing element to be replaced before each production cycle and can be filled with at least a first and a second flowable plastics material, the mold having a fluid pressure connection which can be connected to the sealing element.

4. The sheet material as claimed in claim 1, wherein the sheet material is multicolored.

5. The sheet material as claimed in claim 1, wherein the sheet material is a decorative skin for an inner lining part of a motor vehicle.

6. The method as claimed in claim 2, wherein the sealing element is joined to the plastics material with an integral bond.
